(19) United States
(12) Patent Application Publication
(10) Pub. No.: US 2026/0045080 A1
(43) Pub. Date: Feb. 12, 2026

(54) IMAGE CLASSIFICATION METHOD, SYSTEM, ELECTRONIC DEVICE, AND STORAGE MEDIUM

(71) Applicant: YANGTZE DELTA INDUSTRIAL INNOVATION CENTER OF QUANTUM SCIENCE AND TECHNOLOGY, Suzhou (CN)

(72) Inventors: Feng XIONG, Suzhou (CN); Yuhang GUO, Suzhou (CN); Wei WANG, Suzhou (CN)

(21) Appl. No.: 19/366,550

(22) Filed: Oct. 23, 2025

Related U.S. Application Data
(63) Continuation of application No. PCT/CN2024/131410, filed on Nov. 11, 2024.

(30) Foreign Application Priority Data
Dec. 20, 2023 (CN) 202311756374.1

(51) Int. Cl. G06V 10/82; G06N 3/0464; G06N 3/082; G06V 10/77

(52) U.S. Cl. CPC G06V 10/82; G06N 3/0464; G06N 3/082; G06V 10/7715

(57) ABSTRACT

The disclosure provides an image classification method, system, electronic device, and storage medium, including: acquiring a sample image and using a convolutional neural network module to convert the sample image into one-dimensional feature data; splitting one-dimensional feature data into multiple data segments, and using multiple quantum circuits in the quantum layer module to process all data segments in parallel; concatenating the output results of all quantum circuits to acquire a concatenated vector, and using the classification layer module to output the category prediction results corresponding to the concatenated vector; calculating the loss function value based on the category prediction results and the category labels of sample images, and train an image classification model; an unknown image corresponding to the image recognition task is determined, and the trained image classification model is used to output the image category of the unknown image.

### CROSS-REFERENCE TO RELATED APPLICATIONS

The application is a continuation of International Application No. PCT/CN2024/131410, with an international filing date of Nov. 11, 2024, which is based upon and claims priority to Chinese Patent Application No. 202311756374.1, filed on Dec. 20, 2023, the entire contents of all of which are incorporated herein by reference.

### TECHNICAL FIELD

The disclosure relates to the field of quantum machine learning technology, particularly to an image classification method, system, electronic device, and storage medium.

### BACKGROUND

With the advancement of technology, artificial intelligence and machine learning have achieved significant progress across various fields. However, as the volume of data continues to grow rapidly, traditional machine learning algorithms face considerable challenges in terms of computational complexity and time efficiency when handling complex tasks. Quantum computing, as an emerging computational paradigm, offers the potential to outperform classical computing in solving certain types of problems. In recent years, quantum machine learning, as an interdisciplinary field integrating quantum computing and machine learning, has garnered increasing attention.

In related technologies, hybrid quantum neural networks have been proposed for image classification. Hybrid quantum neural networks combine classical convolutional neural networks with quantum neural networks. However, these hybrid quantum neural networks often require an excessively large number of qubits. And the deep quantum gate operations introduce decoherence effects, ultimately leading to reduced efficiency and accuracy in image classification.

Thus, improving the efficiency and accuracy of image classification remains a technical problem to be addressed by those skilled in the art.

### SUMMARY

The disclosure provides an image classification method, system, electronic device, and storage medium that can improve the efficiency and accuracy of image classification.

To address the above technical problems, the disclosure provides an image classification method applied to an electronic device having an image classification model, wherein the image classification model includes a convolutional neural network module, a quantum layer module, and a classification layer module, and the image classification method includes:
acquiring sample images and using the convolutional neural network module to convert them into one-dimensional feature data;
splitting the one-dimensional feature data into multiple data segments, and using multiple quantum circuits in the quantum layer module to process all of the data segments in parallel;
concatenating the outputs of all the quantum circuits to generate a concatenated vector, and using the classification layer module to output the category prediction result corresponding to the concatenated vector;
calculating the loss function value based on the category prediction results and the category labels of the sample images, and updating the network parameters of the convolutional neural network module and the quantum layer module based on the loss function value, in order to train the image classification model;
upon receiving an image recognition task, determining the unknown image corresponding to the image recognition task, and using the trained image classification model to output the image category of the unknown image.

Optionally, the convolutional neural network module includes a convolutional layer, a pooling layer, and a linear layer;
correspondingly, using the convolutional neural network module to convert the sample image into one-dimensional feature data, includes:
using the convolutional layer to extract features from the sample image, and using the pooling layer to perform maximum pooling operation on the output result of the convolutional layer to acquire the image feature information;
using the linear layer to perform dimensional transformation and linear combination on the image feature information, and acquiring one-dimensional feature data with a predetermined length.

Optionally, the feature extraction of the sample image using convolutional layers includes:
determining the pixel information matrix corresponding to the sample image;
if the number of rows and/or columns of the pixel information matrix is not an integer power of 2, filling the edge of pixel information matrix with an element with a value of 0 to acquire a new pixel information matrix; the number of rows and columns of the new pixel information matrix is an integer power of 2; and
using the convolutional layer to extract features from the new pixel information matrix.

Optionally, using multiple quantum circuits in the quantum layer module to process all the data segments in parallel includes:
allocating all the data segments to multiple quantum circuits based on a predetermined ratio; and
controlling each quantum circuit to process the allocated data segments; each quantum circuit includes a data encoding layer, an entanglement layer, and a measurement layer.

Optionally, controlling each quantum circuit to process the allocated data segments includes:
using the data encoding layer to perform phase encoding operation of single-qubit rotation gate on the allocated data segments, and acquiring the encoded quantum state;
using the entanglement layer to process the encoded quantum state to acquire an entangled quantum state containing training parameters; the entanglement layer includes parameterized single-qubit arbitrary rotation gates and fully-connected controlled-NOT gates between two adjacent qubits;
using the measurement layer to perform full amplitude measurements on a predetermined number of entangled quantum states containing training parameters to acquire the average of single-qubit Pauli matrix; the full amplitude measurement refers to the operation of measuring the projection values of quantum states along the direction of Pauli X matrix, Pauli Y matrix, and Pauli Z matrix, respectively.

Optionally, all the quantum circuits in the quantum layer module run on multiple quantum computers respectively;
correspondingly, the process of training the image classification model also includes:
controlling all quantum circuits running in the same quantum computer to share training parameters.

Optionally, concatenating the output results of all the quantum circuits to acquire a concatenated vector includes:
determining the segment number of each data segment in the one-dimensional feature data; and
concatenating the output results of the quantum circuits corresponding to all the data segments based on the segment numbers, and acquiring the concatenated vector.

The disclosure also provides an image classification system applied to an electronic device having an image classification model, wherein the image classification model includes a convolutional neural network module, a quantum layer module, and a classification layer module, and the image classification system includes:
a feature extraction module that is used to acquire sample images, and the convolutional neural network module is used to convert sample images into one-dimensional feature data;
a parallel processing module that is used to split the one-dimensional feature data into multiple data segments, and multiple quantum circuits in the quantum layer module are used to process all of the data segments in parallel;
a prediction module that is used to concatenate the output results of all the quantum circuits to acquire a concatenated vector, and the classification layer module is used to output the category prediction result corresponding to the concatenated vector;
a training module that is used to calculate the loss function value based on the category prediction results and the category labels of sample images, and the network parameters of the convolutional neural network module and the quantum layer module are updated based on the loss function value, in order to train the image classification model; and
a classification module that is used to, if an image recognition task received, determine the unknown image corresponding to the image recognition task received, and to output the image category of the unknown image using the trained image classification model.

The disclosure also provides a storage medium, including computer executable instructions stored therein, wherein the computer executable instructions, when loaded and executed by a processor, implement the steps of the image classification method described above.

The disclosure also provides an electronic device, including a memory and a processor, wherein the memory stores computer programs, and the processor calls the computer programs in the memory to implement the steps of the image classification method described above.

The disclosure provides an image classification method applied to an electronic device having an image classification model. The image classification model includes a convolutional neural network module, a quantum layer module, and a classification layer module. The image classification method includes: Acquire sample images and using the convolutional neural network module to convert them into one-dimensional feature data. Split the one-dimensional feature data into multiple data segments. Use multiple quantum circuits in the quantum layer module to process all of the data segments in parallel. Concatenate the output results of all the quantum circuits to acquire a concatenated vector. Use the classification layer module to output the category prediction result corresponding to the concatenated vector. Calculate the loss function value based on the category prediction results and the category labels of the sample images. Update the network parameters of the convolutional neural network module and the quantum layer module based on the loss function value, in order to train the image classification model. Upon receiving an image recognition task, determine the unknown image corresponding to the image recognition task. Use the trained image classification model to output the image category of the unknown image.

The image classification scheme provided in the disclosure is realized by an image classification model based on a convolutional neural network module, a quantum layer module, and a classification layer module. In the process of training an image classification model, the disclosure uses a convolutional neural network module to convert sample images into one-dimensional feature data. After splitting the one-dimensional feature data into multiple data segments, the disclosure uses multiple quantum circuits in the quantum layer module to process all the data segments in parallel. After processing sequentially by the convolutional neural network module, quantum layer module, and classification layer module, the disclosure also uses the category prediction results and the category labels of sample images to calculate the loss function value. And the disclosure updates the network parameters of convolutional neural network module and quantum layer module based on the loss function value, in order to train the image classification model. The quantum layer module in the disclosure adopts multiple parallel quantum circuits to reduce the number of qubits and the depth of quantum circuits. After the image classification model is acquired through the above scheme, using the image classification model to process image recognition tasks can improve the efficiency and accuracy of image classification. The disclosure also provides an image classification system, a storage medium, and an electronic device that have the above-mentioned beneficial effects, which will not be further elaborated here.

### BRIEF DESCRIPTION OF THE DRAWINGS

In order to more clearly illustrate the technical solution of the embodiments of the disclosure, a brief introduction will be given to the accompanying drawings required for the description of the embodiments. Obviously, the accompanying drawings described below are some embodiments of the disclosure. Those of ordinary skill in the art can acquire other drawings based on these drawings without creative work.

FIG. 1 is a flowchart of an image classification method provided in an embodiment of the disclosure;

FIG. 2 is a design diagram of a parameterized quantum circuit provided in an embodiment of the disclosure;

FIG. 3 is a flowchart of an image classification scheme based on a hybrid quantum neural network using full amplitude measurement provided in an embodiment of the disclosure;

FIG. 4 is a structural diagram of an image classification model provided in an embodiment of the disclosure;

FIG. 5 is a schematic diagram of a parallelization software computing device of quantum circuit module provided in an embodiment of the disclosure;

FIG. 6 is a structural diagram of an image classification system provided in an embodiment of the disclosure.

### DETAILED DESCRIPTION OF THE EMBODIMENTS

The technical solutions in the embodiments of the disclosure will be described clearly and completely in conjunction with the accompanying drawings of the embodiments of the disclosure. Obviously, the described embodiments are only a part of the embodiments of the disclosure, rather than all the embodiments. Based on the embodiments of the disclosure, all other embodiments acquired by those of ordinary skill in the art without creative work shall fall within the protection scope of the disclosure.

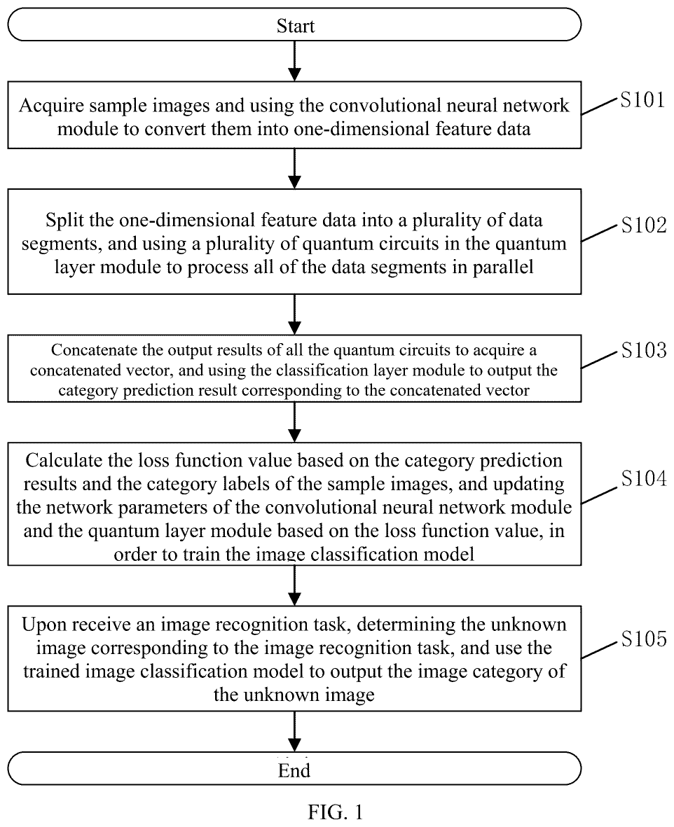

Referring to FIG. 1, and FIG. 1 is a flowchart of an image classification method provided in an embodiment of the disclosure.

### The Specific Steps May Include:

S101: Acquire sample images and use the convolutional neural network module to convert them into one-dimensional feature data.

The embodiment can be applied to an electronic device having an image classification model. The image classification model includes a convolutional neural network module, a quantum layer module, and a classification layer module. The above-mentioned convolutional neural network module, quantum layer module, and classification layer module can be provided in electronic devices having a CPU (Central Processing Unit) and a QPU (Quantum Processing Unit). The above-mentioned convolutional neural network module and classification layer module, for example, can be provided in a classical computer having a CPU. The quantum layer module can be provided in a quantum computer having a QPU. The electronic devices having image classification models include classical computers and quantum computers. Convolutional neural network, a type of feedforward neural network that includes convolutional computation and has a deep structure, can be used to extract nonlinear features of images for the purpose of classification.

The above image classification model can be a classification model for handwritten digit images or a classification model for medical imaging images, which is not specifically limited here. The embodiment can obtain sample images for training image classification models, and the sample images have been added with category tags, that is, the actual categories of the images.

After sample images are obtained, a certain number of sample images can be, in batches, input into the convolutional neural network module of the image classification model. Therefore, the convolutional neural network module can convert the pixel information matrix of sample images into one-dimensional feature data.
S102: Split the one-dimensional feature data into multiple data segments. Use multiple quantum circuits in the quantum layer module to process all of the data segments in parallel.

The quantum layer module of the image classification model includes multiple parallel quantum circuits, also known as quantum circuit parallel modules. This step divides one-dimensional feature data into multiple data segments, and assigns all data segments to each quantum circuit for processing, so that multiple quantum circuits can process all data segments in parallel. The above-mentioned quantum circuit is a parameterized quantum circuit, which is operated by a series of quantum logic gate sequences with adjustable parameters. Its calculation rules conform to the index rise and fall and contraction of tensors.

As a feasible implementation, the embodiment can divide one-dimensional features into multiple equally long data segments, which are one-dimensional data, that is, a part of one-dimensional feature data. The embodiment can allocate all data segments based on the following preset rules: All data segments are allocated. The same data segment is only allocated once. The difference in the number of data segments allocated in any two quantum circuits is less than or equal to the preset value (such as 1 or 2).
S103: Concatenate the output results of all the quantum circuits to acquire a concatenated vector. Use the classification layer module to output the category prediction result corresponding to the concatenated vector.

After each data segment is processed by the quantum circuit, the corresponding output result can be acquired. The disclosure can concatenate the output results of all data segments output by the quantum circuit to acquire a concatenated vector. After acquiring the concatenated vector, input the acquired concatenated vector into the classification layer module of image classification model to acquire the corresponding category prediction results.

As a feasible implementation, the embodiment can determine the segment number of each data segment in the one-dimensional feature data. Concatenate the output results of the quantum circuits corresponding to all the data segments based on the segment numbers. Acquire the concatenated vector.
S104: Calculate the loss function value based on the category prediction results and the category labels of the sample images. Update the network parameters of the convolutional neural network module and the quantum layer module based on the loss function value, in order to train the image classification model.

After the category prediction results of image classification model are acquired for the sample images, the loss function value can be calculated based on the category label of sample images. Then the network parameters of the convolutional neural network module and the quantum layer module can be updated based on the loss function value to train the image classification model.

The embodiment can perform iterative training on the image classification model. That is, loop through the operations of S101-104, and determine a new sample image in each loop. When the number of iterations or the loss function value reaches the preset value, the loop can be ended and the image classification model can be judged as trained. All the quantum circuits in the quantum layer module run on multiple quantum computers respectively. Correspondingly, in the process of training the image classification model, all quantum circuits running in the same quantum computer can also be controlled to share training parameters to improve training efficiency.
S105: Upon receiving an image recognition task, determine the unknown image corresponding to the image recognition task. Use the trained image classification model to output the image category of the unknown image.

If an image recognition task is received after the image classification model is trained, the unknown image corresponding to the image recognition task will be determined. Then input into the trained image classification model. Therefore, the image classification model outputs the image category of the unknown image.

If the image classification model is a classification model for handwritten digit images, the output image category is the handwritten digit content in the unknown image, in order to execute image text recognition. If the image classification model is a medical image classification model, the output image category is the medical image type in the unknown image, in order to achieve accurate classification of medical images.

The image classification scheme provided in the disclosure is realized by an image classification model based on a convolutional neural network module, a quantum layer module, and a classification layer module. In the process of training an image classification model, the disclosure uses a convolutional neural network module to convert sample images into one-dimensional feature data. After splitting the one-dimensional feature data into multiple data segments, use multiple quantum circuits in the quantum layer module to process all the data segments in parallel. After processing sequentially by the convolutional neural network module, quantum layer module, and classification layer module, the embodiment also uses the category prediction results and the category labels of sample images to calculate the loss function value. And the disclosure updates the network parameters of convolutional neural network module and quantum layer module based on the loss function value, in order to train the image classification model. The quantum layer module in the embodiment adopts multiple parallel quantum circuits to reduce the number of qubits and the depth of quantum circuits. After the image classification model is acquired through the above scheme, using the image classification model to process image recognition tasks can improve the efficiency and accuracy of image classification.

As a further introduction to the corresponding embodiment of FIG. 1, the above convolutional neural network module may include sequentially connected convolutional layer, activation function ReLU, pooling layer, and linear layer. The linear layer relates to normalization operation processing and hiding of linear connection layer. The convolutional neural network module can design a classical convolutional neural network that is characterized based on the difficulty level of image classification tasks in the dataset. Then construct the convolutional neural network required for complex image classification.

Correspondingly, the process of processing sample images by the convolutional neural network module is as follows: Use the convolutional layer to extract features from the sample image. Use the pooling layer to perform maximum pooling operation on the output result of the convolutional layer to acquire the image feature information. Use the linear layer to perform dimensional transformation and linear combination on the image feature information. Acquire one-dimensional feature data with a predetermined length.

In further, the convolutional layer needs to process the pixel information matrix of the sample image. If the size of the pixel information matrix does not conform to the optimal processing size of the convolutional layer, elements with a value of 0 can be filled at the edges of the pixel information matrix. One feasible approach is as follows: Determine the pixel information matrix corresponding to the sample image. If the number of rows and/or columns of the pixel information matrix is not an integer power of 2, fill the edge of pixel information matrix with an element with a value of 0 to acquire a new pixel information matrix. The number of rows and columns of the new pixel information matrix is an integer power of 2. Use the convolutional layer to extract features from the new pixel information matrix.

The above process is illustrated by taking handwritten digit recognition as an example:

Package the sample images in the image collection by batch for normalization preprocessing. The number of samples in each batch can be set to 1, 32, 64, 128, etc. The input data information of each sample image includes the pixel values of a matrix with a size of n×n and a classification label (that is, category label), with a length of 1, of that image. All the specific numbers marked in the legends in the embodiment are based on the example of MNIST (Mixed National Institute of Standards and Technology database, a handwritten digit recognition dataset). The training sample set includes handwritten digits 0-9, 10 categories in total, and the pixel information matrix size of each digital image is 28×28, and 64 samples are processed in each batch. The MNIST dataset, a binary image dataset ranging from handwritten digits 0 to 9, is used to train various image processing systems. And it contains a training set of 60,000 sample images and a testing set of 10,000 sample images.

The embodiment can input the data stream of sample image into the convolutional neural network module for processing. The convolutional neural network module mainly includes a convolutional layer, a pooling layer, an activation function ReLU, and a linear layer. Because the convolutional neural network required to complete more complex image classification is relatively complex. The convolutional neural network module can be designed as a classical convolutional neural network. And it can be characterized based on the difficulty level of the image classification task in the dataset. After the sample image is processed through the convolutional layer and pooling layer, and the pixel information matrix with an original size of n×n will be stretched. And the pixel information matrix will eventually become one-dimensional feature data with a length of m (m<n×n) and output to the next layer module, namely the quantum layer module.

Specifically, the convolutional neural network module designed for recognizing handwritten digit sets is executed as follows:

The pixel information matrix of a sample image, with an input size of 28×28, becomes 32×32 after the edge fill circle of 2 (with the filled number as 0). The convolutional layer selected in the embodiment has 20 features. Each convolution kernel has a size of 5×5 and a step length of 1. The function of the convolution kernel is to extract local features of original image. The matrix size following the action of convolution layer is 20×28×28. Each convolution kernel is a linear combination y=w^{T}x+b with training parameters about the sample image block matrix. x is a block matrix of filled sample image. w^{T} is the weight parameter to be trained in the convolution kernel. b is the bias parameter inside each neuron in the convolution kernel. y is the output result of convolution layer.

In order to mimic the working properties of neurons in living organisms, when the input signal inside the neuron exceeds a certain threshold, the signal will be transmitted to the next layer. The activation function ReLU is expressed as follows:

$$y = \{ \begin{matrix}y , {w}^{T} x + b \geq 0 \\ 0 , {w}^{T} x + b < 0\end{matrix} .$$

In order to reduce the number of training parameters in the convolutional layer and maximize the preservation of feature information in the sample image, the embodiment uses a pooling layer to select representative information from the matrix. Therefore, above information can effectively participate in the training of the next layer of neural network. In some embodiments, the maximum pooling layer method is used, that is, only the maximum value in the pooling layer as a 2×2 matrix is retained. The matrix size is 20×28×28 following the action of the convolutional layer with ReLU activation function, and becomes 20×14×14 following the action of the max pooling layer with a step length of 2. The matrix size is ¼ of the size when experiencing the convolutional layer.

Following the processing by the convolutional layer and pooling layer, the feature information of each sample image is extracted into a high-order matrix with dimensions of (20, 14, 14) in length, width, and height. The linear layer can be straightened into a one-dimensional vector with a length of 3920, without changing the length of the total elements of the high-order matrix. In order to further reduce the complexity of training parameters, the vector with a length of 3920 is reduced to a vector with a length of 30 through linear combination. The one-dimensional feature data with a fixed length is generated. The one-dimensional feature data finally output by the linear layer is the input data of the quantum layer module. Therefore, for algorithm designing, the size of the one-dimensional feature data can be determined based on the number of computable qubits of existing quantum computer hardware and the number of available quantum computer devices.

As a further introduction to the corresponding embodiment of FIG. 1, after one-dimensional feature data is split into multiple data segments, all the data segments can be allocated to multiple quantum circuits based on a predetermined ratio. And each quantum circuit can be controlled to process the allocated data segments.

Each quantum circuit includes a data encoding layer, an entanglement layer, and a measurement layer. The entanglement layer includes parameterized single-qubit arbitrary rotation gates and fully-connected controlled-NOT gates between two adjacent qubits. The quantum circuits process each data segment as follows: Use the data encoding layer to perform phase encoding operation of single-qubit rotation gate on the allocated data segments. Acquire the encoded quantum state. Use the entanglement layer to process the encoded quantum state to acquire an entangled quantum state containing training parameters. Use the measurement layer to perform full amplitude measurements on the predetermined number of entangled quantum states containing training parameters. Acquire the average of single-qubit Pauli matrix. The predetermined number can be less than the total number of entangled quantum states. The full amplitude measurement refers to the operation of measuring the projection values of quantum states along the direction of Pauli X matrix, Pauli Y matrix, and Pauli Z matrix, respectively. That is, the operation of measuring quantum state projection values in directions X, Y, and Z. The Pauli matrix, a mathematical matrix used to describe a two-level quantum state system, has the following properties: 1) Multiplying by itself yields the identity matrix. 2) Multiplying the Pauli matrix by the unit matrix yields the Pauli matrix itself. The most basic Pauli matrices are the single-qubit Pauli X matrix, Pauli Y matrix, and Pauli Z matrix.

The above process is illustrated by taking handwritten digit recognition as an example:

In some embodiments, the one-dimensional feature data with a length m of 30 obtained through the processing by the convolutional neural network module can be input into the quantum layer module. In order to adapt to the experimental accuracy of small and medium-sized quantum computer devices with noise, the number of qubits used in quantum circuits in quantum algorithm is as small as possible. And the depth of quantum gate circuit be shallow to ensure relatively reliable quantum experimental results. In order to improve the computational efficiency of quantum computing and make full use of existing quantum computing resources, the “divide-and-rule” approach can be adopted. That is, dividing large one-dimensional feature data into several data segments firstly, and using a quantum computer to process independent data segments in parallel. The process of parallel processing of data fragments mentioned above can be performed in different connected configuration qubit regions of the same quantum hardware device. That is, to execute parallel processing within the same quantum computing node. The process of parallel processing of data fragments mentioned above can also be performed in the connected regions of different quantum hardware devices. That is, to execute distributed parallel processing between different quantum computers (that is, quantum nodes). Through the above process, each independent quantum circuit will sequentially return the measured results to the electronic computing device. Based on combination, form the input of the fully connected layer of classification layer module.

Specifically, each independent quantum circuit is divided into three parts: a data encoding layer, an entanglement layer, and a measurement layer (that is, a local full amplitude measurement layer).

Taking the three quantum circuits as an example, the linear layer of convolutional neural network module outputs one-dimensional feature data with a length of 30. The one-dimensional feature data is evenly arranged to the three quantum circuits based on the vector label index positions 0-9, 10-19, 20-29. Each independent quantum circuit will receive data segments of partial length output by the linear layer. Due to the small amount of data in the data fragments, the phase encoding method of single-qubit rotation gate can be directly selected as the loading method of data encoding layer. For example, the rotation gate Rₓ (πθ) around the x-axis. θ corresponds to a single classical data assigned to a single qubit in the quantum circuit. The phase encoding method of single-qubit rotation gate mentioned above is a way of encoding by loading classical data onto the argument of single-qubit rotation gate that regulates the quantum state.

After being processed by the data encoding layer, classical data information has been loaded into the quantum state. The designed entanglement layer in some embodiments includes single-qubit arbitrary rotation gates R (α, β, γ) and fully-connected controlled-NOT gates (CNOT gates) between two adjacent qubits. Through the above method, shallow quantum circuit gates can be used to achieve global entanglement in the space where the qubits are located. The α and γ in the aforementioned single-qubit arbitrary rotation gate R (α, β, γ) represent the rotation angles around different rotation axes. B represents the global phase of the quantum state. In order to save the number of parameters during training, different quantum circuits can share the same set of training parameters.

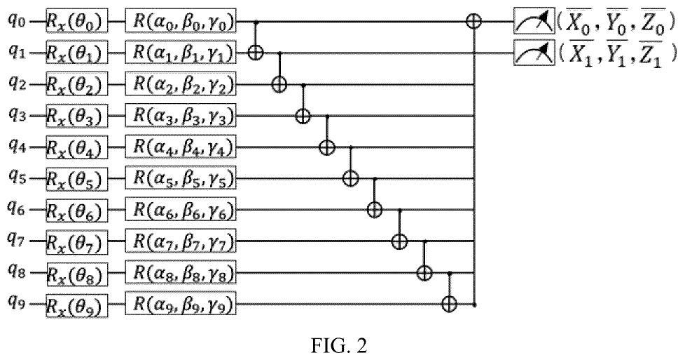

After entanglement layer processing, the qubits in the quantum circuit exhibit a highly entangled state. For the measurement layer, the projections of the entangled state of the quantum circuit along the directions of Pauli X, Y, and Z matrix in the subspaces of certain qubits are selected. After multiple measurements, the average value of the single-qubit Pauli matrix (X̅ₗ, Y̅ₗ, Z̅ₗ) can be returned. i represents the serial number of the single-qubit, i=0, 1, 2 . . . . Referring to FIG. 2, and FIG. 2 is a design diagram of a parameterized quantum circuit provided in an embodiment of the disclosure. For example, in FIG. 2, the selected subspace is marked as qubit 0 and qubit 1 in the quantum circuit. Each quantum circuit will return a vector of length 6: (X̅₀, Y̅₀, Z̅₀, X̅₁, Y̅₁, Z̅₁). In the figure, q₀-q₉ represents qubits, Rₓ(θ₀)—Rₓ (θ₉) represents x-axis rotation gates, and R(α₀, β₀, γ₀)—R(α₉, β₉, γ₉) represents single-qubit arbitrary rotation gates.

In further, the classification layer module can receive the measurement values of each quantum circuit in the quantum layer module. Sequentially connect them to form a concatenated vector with a length of 18. Afterwards, a concatenated vector with a length of 18 is linearly connected to a vector classification layer with a length of 10. And the normalized exponential function Softmax is used to output the probabilities of belonging to each of the 10 categories. The index of the output maximum probability value corresponds to the specific classification of the sample.

The process described in the above embodiments is illustrated below through practical applications.

In the current era of artificial intelligence and big data, hardware and algorithms based on traditional computing power can no longer meet the processing and analysis needs for massive data generated in human life and social production activities. Quantum computers are based on the principle of quantum mechanics superposition state and the entanglement characteristics of quantum state. And they can theoretically provide exponential-order parallel data processing and storage capabilities at fast execution speeds. On the other hand, quantum states prepared by quantum computers are susceptible to environmental noise. So currently the quantum computers, which hardware is still in its infancy, has not completely replaced classical computers. In order to adapt to the current hardware conditions of quantum computers, it can seek algorithm applications that combine quantum and classical computing. Specifically, traditional neural network machine learning has achieved remarkable success in the field of image classification and has been successfully executed. In the new field of quantum machine learning, it is highly valuable and promising to study the algorithmic application of hybrid quantum neural networks in image classification.

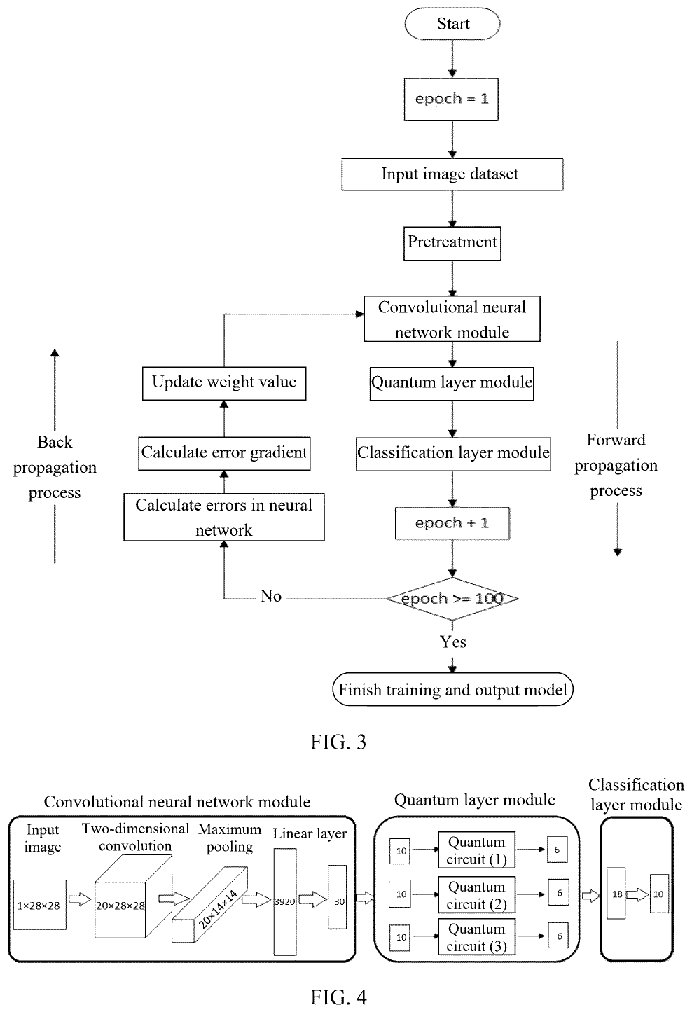

Referring to FIG. 3, and FIG. 3 is a flowchart of an image classification scheme based on a hybrid quantum neural network using full amplitude measurement provided in an embodiment of the disclosure. After starting, set the iteration number epoch to 1. Input and preprocess image training dataset. Process the sample images in the image training dataset sequentially by the convolutional neural network module, quantum layer module, and classification layer module. After setting the iteration number epoch to +1, determine whether the iteration number epoch is greater than or equal to 100. If so, end the training and output the model. If not, calculate the error in the neural network, calculate the error gradient, and update the weights. The process of training a hybrid quantum neural network includes forward propagation and backward propagation.

The embodiment provides an image classification scheme based on a hybrid quantum neural network using full amplitude measurement, including the following steps:

Step 1: Package the sample images in the image collection by batch for normalization preprocessing.

This step can be executed based on the image data loading module. By standardizing the image collection to be classified, the image data loading module determines the number of image samples in each batch, and packages the data samples in batches.

Step 2: Input the sample images of the current batch into the convolutional neural network module to acquire one-dimensional feature data.

Step 3: Split the one-dimensional feature data into multiple data segments. Input the data segments into multiple quantum circuits of the quantum layer module for computation.

The quantum layer module can achieve block parallel structured design of large data at different quantum computer nodes or in different qubit processor regions of the same quantum computer. A local full amplitude measurement method can be adopted for the quantum output layer of the quantum layer module.

The embodiment adopts the idea of splitting big data into data segments, which can be processed in parallel between or within quantum computers. The loading method of quantum circuit data is direct argument encoding. The parameters in the quantum circuit layer can be set to be, based on training requirements, shared within the same quantum computer but not shared between different quantum computers. The local qubit full amplitude measurement method selected for the quantum measurement layer can autonomously set the selected measurement qubit positions based on the dimension of the input data of quantum layer.

Step 4: Concatenate the output results of multiple quantum circuits to acquire a concatenated vector. Use the classification layer module to output the class prediction result corresponding to the concatenated vector.

The classification layer module, also known as the fully connected layer classification module, is used to define the training network parameters for loss function iterative optimization.

Step 5: In each round of training, based on the category prediction results and category labels, calculate the batch average cross entropy function

$$Loss = - 1 / {n}_{b s} {\sum }_{i}^{{n}_{b s}} {y}_{i} log {p}_{i} .$$

n_{bs} is the size of the batch processed images in each round of training data. yᵢ is the true classification label of the i-th image sample in each round of training batch processing. pᵢ is the probability that the image sample belongs to the true label predicted by the hybrid quantum neural network. From a theoretical analysis, the closer the cross entropy is to 0, the higher the prediction accuracy of hybrid neural network. Perform round iteration based on cross entropy, return to step 1 to input the next batch of processed image samples. Gradually update the parameters in the hybrid quantum neural network. The backward propagation iteration parameters are selected here. In this step, calculate the gradient of loss function relative to each parameter (weight and bias) in the neural network. This is calculated by using the chain rule to propagate errors backwards along each connection in the network. The error signal gradually propagates back to the input layer from the output layer. After updating the parameters back to the input layer, input a new batch of training images. Repeat steps 2-4 of the hybrid quantum neural network (that is, image classification model) to acquire a new round of cross entropy. Until the maximum number of rounds set by the program is reached and the cross-entropy value decreases and converges to a minimum value. The program ends and all parameter values in the hybrid quantum neural network are saved.

Step 6: Enter a test dataset that is independent of the training dataset. Initialize a hybrid quantum neural network model that is equivalent to the training dataset. Substitute the training parameter values acquired in Step 5 into the model to acquire the classification corresponding to the maximum prediction probability value of the input image. Compare the predicted classification with the true classification. The image classification is correct if the two are the same, otherwise it is incorrect. Traverse all samples in the test dataset. Record the number of correctly predicted samples. Divide by the total number of test samples to acquire the sample prediction accuracy of the model. In the above scheme, the prediction accuracy for MNIST dataset with a size of 10,000 test samples is 98.50%, with an average cross entropy of 0.0077. It is higher than the classification accuracy of 94.1% mentioned in related technologies.

Referring to FIG. 4, and FIG. 4 is a structural diagram of an image classification model provided in an embodiment of the disclosure. The image classification model includes an input layer module, a convolutional neural network module, a quantum layer module, and a classification layer module. In the convolutional neural network module, after an image is input, two-dimensional convolution operation, max pooling operation, and linear layer processing can be performed on the convolutional layer. The output results entering the convolutional neural network module are processed using quantum circuits (1), (2), and (3). The numbers 1×28×28, 20×28×28, 20×14×14, 3920, 30, 10, 6, 18, and 10 in FIG. 4 represent the size of the features.

In some embodiments, the convolutional neural network module may have relatively few convolutional layers and linear layers. The quantum layer module in some embodiments fully considers the hardware characteristics of current quantum computers: 1) Based on the number of qubits in current quantum computing devices, a data splitting method is proposed. A parallel processing calculation method for multi device small qubit quantum circuit is used. This method can effectively mitigate the impact of decoherence factors in quantum states caused by excessive number of circuit qubits and deep gate circuit operations. Thus, it reduces the error of final experimental measurement data and improving the utilization of quantum computing device resources. 2) Based on the characteristics of quantum state entanglement and experimental methods of quantum measurement, a few single-qubit full amplitude spaces are selected for sampling measurement. The advantage is that it can ensure as much projection information of the overall entangled state in the subspace as possible. It also effectively avoids reading errors caused by interference from multiple qubit simultaneous reading of measurement string signals.

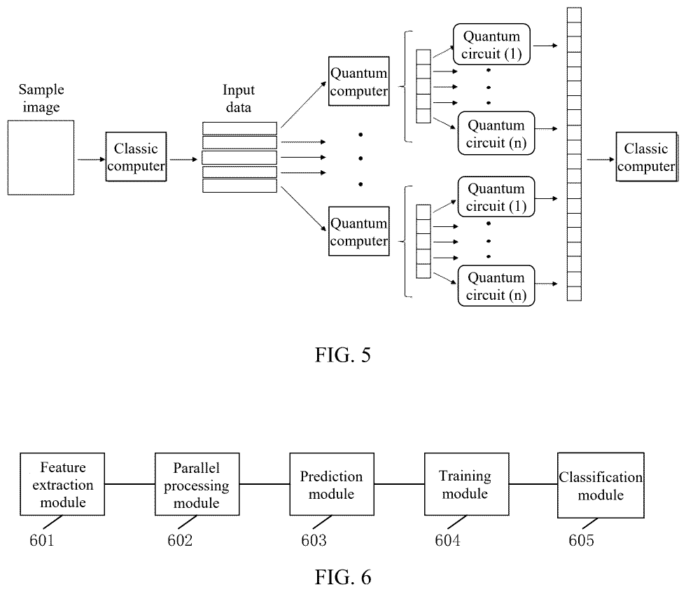

In some embodiments, the convolutional neural network module and the classification layer module run on a classical computer. The quantum layer module runs on a quantum computer. Referring to FIG. 5. FIG. 5 is a schematic diagram of a parallelization software computing device of quantum circuit module provided in an embodiment of the disclosure. After the sample image is processed by the convolutional neural network module of the classical computer, the data is input to the quantum computer. The quantum circuits 1˜n of the quantum layer module in the quantum computer process the data and return the processing result to the classification layer module of the classical computer.

The embodiment can be applied to the classification of MNIST handwritten digit sets and can also be transplanted to other image datasets. In some embodiments, a parallelized parameter sharing quantum circuit layer is used in the convolutional neural network module. It not only greatly improves the ability and efficiency of data processing, but also greatly reduces the parameters required for training. The idea of dividing large data blocks into smaller ones for “divide-and-rule” in some embodiments is of great significance for the era of medium scale quantum computers with noise. It not only solves the pain point of the current data demand for ultra large-scale qubit numbers, but also effectively reduces the depth of quantum circuits with ultra large-scale qubit numbers. The quantum layer module takes the locally measured full amplitude values as the output. This also indicating that the information of the globally entangled state can be effectively projected and compressed into one of its subspaces after being characterized by training parameters. Thus, proving that the quantum circuit layer is a highly entangled network. Compared to the mere measurement of the projection of qubits in one direction, local full amplitude measurement can effectively reduce the dimensionality of quantum circuit output layer data while ensuring accuracy. From the perspective of quantum hardware reading, in some embodiments, reading local qubits has a smaller reading error than reading all qubits. It is reflected in the reduced number of reads and of qubit points that need to be read simultaneously.

Referring to FIG. 6, and FIG. 6 is a structural diagram of an image classification system provided in an embodiment of the disclosure. The system can be applied to an electronic device having an image classification model. The image classification model includes a convolutional neural network module, a quantum layer module, and a classification layer module. The image classification system includes:
a feature extraction module 601 that is used to acquire sample images. The convolutional neural network module is used to convert sample images into one-dimensional feature data;
a parallel processing module 602 that is used to split the one-dimensional feature data into multiple data segments. Multiple quantum circuits in the quantum layer module are used to process all of the data segments in parallel;
a prediction module 603 that is used to concatenate the output results of all the quantum circuits to acquire a concatenated vector. The classification layer module is used to output the category prediction result corresponding to the concatenated vector;
a training module 604 that is used to calculate the loss function value based on the category prediction results and the category labels of sample images. The network parameters of the convolutional neural network module and the quantum layer module are updated based on the loss function value, in order to train the image classification model; and
a classification module 605 that is used to, if an image recognition task received, determine the unknown image corresponding to the image recognition task received, and to output the image category of the unknown image using the trained image classification model.

The image classification scheme provided in the disclosure is realized by an image classification model based on a convolutional neural network module, a quantum layer module, and a classification layer module. In the process of training an image classification model, the disclosure uses a convolutional neural network module to convert sample images into one-dimensional feature data. After splitting the one-dimensional feature data into multiple data segments, use multiple quantum circuits in the quantum layer module to process all the data segments in parallel. After processing sequentially by the convolutional neural network module, quantum layer module, and classification layer module, the embodiment also uses the category prediction results and the category labels of sample images to calculate the loss function value. Then the embodiment updates the network parameters of convolutional neural network module and quantum layer module based on the loss function value, in order to train the image classification model. The quantum layer module in some embodiments adopts multiple parallel quantum circuits to reduce the number of qubits and the depth of quantum circuits. After the image classification model is acquired through the above scheme, using the image classification model to process image recognition tasks can improve the efficiency and accuracy of image classification.

In further, the convolutional neural network module includes a convolutional layer, a pooling layer, and a linear layer.

Correspondingly, the feature extraction module 601 uses the convolutional neural network module to convert the sample image into one-dimensional feature data, including the following process: Use the convolutional layer to extract features from the sample image. Use the pooling layer to perform maximum pooling operation on the output result of the convolutional layer to acquire the image feature information. Use the linear layer to perform dimensional transformation and linear combination on the image feature information. Acquiring one-dimensional feature data with a predetermined length.

In further, the feature extraction module 601 uses convolutional layers to extract features from the sample image, including the following process: Determine the pixel information matrix corresponding to the sample image. If the number of rows and/or columns of the pixel information matrix is not an integer power of 2, fill the edge of pixel information matrix with an element with a value of 0 to acquire a new pixel information matrix. The number of rows and columns of the new pixel information matrix is an integer power of 2. Use the convolutional layer to extract features from the new pixel information matrix.

In further, the parallel processing module 602 uses multiple quantum circuits in the quantum layer module to process all the data segments in parallel, including the following process: Allocate all the data segments to multiple quantum circuits based on a predetermined ratio. Controlling each quantum circuit to process the allocated data segments. Each quantum circuit includes a data encoding layer, an entanglement layer, and a measurement layer.

In further, the parallel processing module 602 controls each quantum circuit to process the allocated data segments, including the following process: Use the data encoding layer to perform phase encoding operation of single-qubit rotation gate on the allocated data segments. Acquire the encoded quantum state. Use the entanglement layer to process the encoded quantum state to acquire an entangled quantum state containing training parameters. The entanglement layer includes parameterized single-qubit arbitrary rotation gates and fully-connected controlled-NOT gates between two adjacent qubits. Use the measurement layer to perform full amplitude measurements on a predetermined number of entangled quantum states containing training parameters to acquire the average of single-qubit Pauli matrix. The full amplitude measurement refers to the operation of measuring the projection values of quantum states along the direction of Pauli X matrix, Pauli Y matrix, and Pauli Z matrix, respectively.

In further, all the quantum circuits in the quantum layer module run on multiple quantum computers, respectively;
correspondingly, further including:
a parameter sharing module that is used to, during the process of training the image classification model, control all quantum circuits running in the same quantum computer to share training parameters.

In further, the prediction module 603 concatenates the output results of all the quantum circuits to acquire a concatenated vector, including the following process: Determine the segment number of each data segment in the one-dimensional feature data. Concatenate the output results of the quantum circuits corresponding to all the data segments based on the segment numbers. Acquire the concatenated vector.

As the implementation examples of the system part correspond to those of the method part, referring to the description of the implementation examples of the method part for those of the system part, which will not be elaborated here.

The disclosure also provides a storage medium storing a computer program which, when executed, implements the steps of the image classification method described above. The storage medium may include various media that can store program code, for example, USB flash drives, portable hard drives, Read Only Memory (ROM), Random Access Memory (RAM), magnetic disks, or optical disks.

The disclosure also provides an electronic device, which may include a memory and a processor. The memory stores computer programs. The computer programs in the memory, when called by the processor, can implement the steps provided in the above embodiments. Of course, the electronic device may also include various components such as network interfaces, power supplies, and so on.

The various embodiments in the specification are described in a progressive manner. The differences from other embodiments are emphasized in detail in each embodiment. The same and similar parts between the embodiments can be referred to each other. The system disclosed in the embodiments is described in a relatively simple manner as it corresponds to the method disclosed in the embodiments. Refer to the method part for relevant information. It should be noted that the person having ordinary skill in the art can make several improvements and modifications to the disclosure without departing from the principles of the disclosure. And these improvements and modifications also fall within the scope of protection of the claims of the disclosure.

It should also be noted that relationship terms in the specification, such as first and second, are only used to distinguish one entity or operation from another. It does not necessarily require or imply any such actual relationship or order between these entities or operations. Moreover, the terms ‘including’, ‘comprising’, or any other variation thereof are intended to encompass non-exclusive inclusion. Therefore, a process, method, item, or device that includes a series of elements, not only includes those elements, but also other elements not explicitly listed, or elements inherent to such process, method, item, or device. Without further limitations, the element defined by the statement ‘including . . . ’ does not exclude the existence of other identical elements in the process, method, item, or device that includes the element in question.

What is claimed is:

1. An image classification method applied to an electronic device having an image classification model, wherein the image classification model comprises a convolutional neural network module, a quantum layer module, and a classification layer module, and the image classification method comprises:
acquiring a sample image and using the convolutional neural network module to convert the sample image into a one-dimensional feature data;
splitting the one-dimensional feature data into a plurality of data segments, and using a plurality of quantum circuits in the quantum layer module to process all of the data segments in parallel;
concatenating output results of all the quantum circuits to acquire a concatenated vector, and using the classification layer module to output a category prediction result corresponding to the concatenated vector;
calculating a loss function value based on the category prediction result and a category label of the sample image, and updating a network parameter of the convolutional neural network module and the quantum layer module based on the loss function value, in order to train the image classification model;
upon receiving an image recognition task, determining an unknown image corresponding to the image recognition task, and using the trained image classification model to output an image category of the unknown image.

2. The image classification method of claim 1, wherein the convolutional neural network module comprises a convolutional layer, a pooling layer, and a linear layer;
correspondingly, using the convolutional neural network module to convert the sample image into the one-dimensional feature data, comprises:
using the convolutional layer to extract features from the sample image, and using the pooling layer to perform maximum pooling operation on an output result of the convolutional layer to acquire an image feature information;
using the linear layer to perform dimensional transformation and linear combination on the image feature information, and acquiring the one-dimensional feature data with a predetermined length.

3. The image classification method of claim 2, wherein the feature extraction of the sample image using convolutional layers comprises:
determining a pixel information matrix corresponding to the sample image;
if a number of rows and/or columns of the pixel information matrix is not an integer power of 2, filling the edge of the pixel information matrix with an element with a value of 0 to acquire a new pixel information matrix; a number of rows and columns of the new pixel information matrix is an integer power of 2; and
using the convolutional layer to extract features from the new pixel information matrix.

4. The image classification method of claim 1, wherein using the plurality of quantum circuits in the quantum layer module to process all of the data segments in parallel comprises:
allocating all the data segments to the plurality of quantum circuits based on a predetermined ratio; and
controlling each quantum circuit to process the allocated data segments; each quantum circuit comprises a data encoding layer, an entanglement layer, and a measurement layer.

5. The image classification method of claim 4, wherein controlling each quantum circuit to process the allocated data segments comprises:
using the data encoding layer to perform phase encoding operation of single-qubit rotation gate on the allocated data segments, and acquiring an encoded quantum state;
using the entanglement layer to process the encoded quantum state to acquire an entangled quantum state containing training parameters; wherein the entanglement layer comprises a parameterized single-qubit arbitrary rotation gate and a fully-connected controlled-NOT gate between two adjacent qubits;
using the measurement layer to perform full amplitude measurement on a predetermined number of entangled quantum states containing training parameters to acquire an average of single-qubit Pauli matrix; wherein the full amplitude measurement refers to the operation of measuring the projection values of quantum states along the direction of Pauli X matrix, Pauli Y matrix, and Pauli Z matrix, respectively.

6. The image classification method of claim 1, wherein all the quantum circuits in the quantum layer module run on a plurality of quantum computers respectively;
correspondingly, the process of training the image classification model also comprises:
controlling all the quantum circuits running in the same quantum computer to share training parameters.

7. The image classification method of claim 1, wherein concatenating the output results of all the quantum circuits to acquire the concatenated vector comprises:
determining a segment number of each data segment in the one-dimensional feature data; and
concatenating the output results of the quantum circuits corresponding to all the data segments based on the segment numbers, and acquiring the concatenated vector.

8. The image classification method of claim 2, wherein concatenating the output results of all the quantum circuits to acquire the concatenated vector comprises:
determining a segment number of each data segment in the one-dimensional feature data; and
concatenating the output results of the quantum circuits corresponding to all the data segments based on the segment numbers, and acquiring the concatenated vector.

9. The image classification method of claim 3, wherein concatenating the output results of all the quantum circuits to acquire the concatenated vector comprises:
determining a segment number of each data segment in the one-dimensional feature data; and
concatenating the output results of the quantum circuits corresponding to all the data segments based on the segment numbers, and acquiring the concatenated vector.

10. The image classification method of claim 4, wherein concatenating the output results of all the quantum circuits to acquire the concatenated vector comprises:
determining a segment number of each data segment in the one-dimensional feature data; and
concatenating the output results of the quantum circuits corresponding to all the data segments based on the segment numbers, and acquiring the concatenated vector.

11. The image classification method of claim 5, wherein concatenating the output results of all the quantum circuits to acquire the concatenated vector comprises:
determining a segment number of each data segment in the one-dimensional feature data; and
concatenating the output results of the quantum circuits corresponding to all the data segments based on the segment numbers, and acquiring the concatenated vector.

12. The image classification method of claim 6, wherein concatenating the output results of all the quantum circuits to acquire the concatenated vector comprises:
determining a segment number of each data segment in the one-dimensional feature data; and
concatenating the output results of the quantum circuits corresponding to all the data segments based on the segment numbers, and acquiring the concatenated vector.

13. An image classification system applied to an electronic device having an image classification model, wherein the image classification model comprises a convolutional neural network module, a quantum layer module, and a classification layer module, and the image classification system comprises:
a feature extraction module that is used to acquire a sample image, and the convolutional neural network module is used to convert the sample image into a one-dimensional feature data;
a parallel processing module that is used to split the one-dimensional feature data into a plurality of data segments, and a plurality of quantum circuits in the quantum layer module are used to process all of the data segments in parallel;
a prediction module that is used to concatenate output results of all the quantum circuits to acquire a concatenated vector, and the classification layer module is used to output a category prediction result corresponding to the concatenated vector;
a training module that is used to calculate a loss function value based on the category prediction results and a category label of sample images, and a network parameter of the convolutional neural network module and the quantum layer module are updated based on the loss function value, in order to train the image classification model; and
a classification module that is used to, if an image recognition task received, determine an unknown image corresponding to the image recognition task received, and to output an image category of the unknown image using the trained image classification model.

14. An electronic device, comprising:
a memory and a processor, wherein the memory stores a computer program, and the processor calls the computer program in the memory to implement the steps of image classification method of claim 1.
